(19) United States
(12) Patent Application Publication
(10) Pub. No.: US 2010/0146793 A1
(43) Pub. Date: Jun. 17, 2010

(54) Skinning Knife

(76) Inventor: John Richard Jamison, Eugene, OR (US)

Correspondence Address: Davis Wright Tremaine LLP - Portland;William A. Birdwell, 1300 S.W. Fifth Avenue, SUITE 2300, Portland, OR, 97201-5630, US

(21) Appl. No.: 12/699,772

(22) Filed: Feb. 3, 2010

Related U.S. Application Data
(63) Continuation-in-part of application No. 12/142,699, filed on Jun. 19, 2008.

(51) Int. Cl. A22B 5/16; B26B 1/08; B26B 1/02

(52) U.S. Cl. 30/123.6; 30/162; 30/123.7; 30/143; 30/293

(57) ABSTRACT

A skinning knife comprising a handle, a convex skinning blade, and one or more spreading members disposed at the forward most position of the knife so as to spread apart two portions of an animal hide that have been separated as the knife is thrust forwardly. A preferred embodiment also features a slitting blade disposed at a forward portion of the handle and having an upwardly- and forwardly-directed cutting edge, and a retractable punch blade disposed in the handle beneath the slitting blade for opening a hole in the hide when the knife is thrust forwardly, the first spreading member having a slot therein for receiving the punch blade. A blade actuation mechanism is provided for selectively moving the punch blade forwardly and rearwardly through the slot in the first spreading member. In alternative embodiments, an actuation mechanism moves the skinning blade or the spreading member.

This application is a continuation-in-part of U.S. patent application Ser. No. 12/142,699, filed on Jun. 19, 2008.

### BACKGROUND OF THE INVENTION

1. Field of the Invention

This invention relates generally to knives for removing a first, covering material from a second, underlying material and particularly to knives for removing the hide from the musculature of a dead animal.

2. Description of the Related Art

Once an animal has been killed in a hunt it is ordinarily necessary to field dress and skin the animal. Skinning involves removing the hide of the animal from the musculature, or meat, of the animal with minimal damage to either the meat or the hide (or to the fur, if applicable), which is a challenging task.

Various tools have been devised to assist a hunter in skinning an animal that has been killed in hunting. Generally, the idea is to slit the hide and lift it from the meat without damaging the meat. One such tool is shown in Montgomery U.S. Pat. No. 4,607,432, which employs an arm having a spreading member at one end and that is pivotally attached to a knife at the other end so that the spreading member may be placed under the tip of the knife blade to lift the hide off the meat as the hide is slit. However, this device can be awkward to use because of the wide-swinging arm and the spreading member includes fairly narrow walls that concentrate force on the meat.

Another such tool is shown in Crist U.S. Pat. No. 4,937,941. In this case, a removable spreading member fits over the tip of the knife and is held in place by a strap. However, this too may be awkward to use because the spreading member and strap hang loosely when the spreading member is not attached to the tip and, when the spreading member is attached to the tip, the spreading member covers a portion of the blade that is most useful in slitting the hide.

Other existing skinning tools sold by, for example, by Gerber Legendary Blades or Leatherman, Inc., both of Portland, Oreg., utilize a concave hook that is used in a pulling motion to separate hide from flesh, which motion raises a safety concern because a blade is directed toward the user.

It has been found that there is a need for a better skinning knife that provides a safer, more effective, and convenient to use spreading member, and that is more versatile in its function.

### BRIEF SUMMARY OF THE INVENTION

The present invention meets the aforementioned need by providing a skinning knife that has a fixedly attached spreading member and a convex skinning blade within a single tool, in which the design and position of the fixedly attached spreading member, which is typically used first, does not subsequently obstruct or otherwise compromise the utility of the blade. Six different embodiments are presented, five of which feature an activation mechanism that provides for multiple positions of the fixed spreading member relative to one or more sharpened blades.

A preferred embodiment of a skinning knife comprises a handle, having a forward portion, a grip portion disposed behind the forward portion, an upper portion and a lower portion; a slitting blade disposed at the forward portion and having an upwardly- and forwardly-directed cutting edge so as to cut the animal hide, or other material, encountered as the knife is thrust forwardly; a first fixedly attached spreading member disposed at the forward most position of the forward portion so as to spread apart two portions of hide or other material that have been separated by the slitting blade as the knife is thrust forwardly, the spreading member having a three-dimensional forwardly convex surface for engaging and spreading the two portions of material; and a retractable punch blade disposed at least partially in the forward portion beneath the slitting blade for opening a hole in the first hide or other material when the knife is thrust forwardly, the punch blade having a forward end and a rearward end, the forward end having a cutting edge, the first spreading member having a slot therein for receiving the punch blade, and the handle having a punch blade actuation mechanism for selectively moving the punch blade forwardly through the slot in the first spreading member and in front thereof and moving the punch blade rearwardly through the slot so as not to protrude forwardly beyond the forwardly convex surface of the first spreading member.

The invention may also provide a second spreading member disposed below and forward of the first spreading member, the second spreading member also having a three-dimensional forwardly convex surface, or the two convex surfaces may be provided by a single spreading member. The invention may also be further provided with a downwardly directed convex skinning blade for separating the hide of an animal from the meat. In its simplest embodiment, the invention may comprise a handle, a fixed blade, and a fixedly attached spreading member, used in a forwardly-directed motion to skin the animal, the relative sizes of the parts being adapted to the size and thickness of the animal hide. In each of the embodiments, the use of a fixedly attached, convex spreading member allows the skinning knife to be wielded in a forward motion, away from the user, thus improving its safety over tools that include sharp components and that are used with a pulling motion.

It is to be understood that this summary is provided as a means for generally determining what follows in the drawings and detailed description, and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 shows a side view of a preferred embodiment of a skinning knife according to the invention.

FIG. 2 shows a side view of the embodiment of FIG. 1 with a forward portion partially cut away to reveal the interior of the skinning knife with a latch in a forward position.

FIG. 3 shows a side view of the embodiment of FIG. 1 with a forward portion partially cut away to reveal the interior of the skinning knife with the latch in a rearward position.

FIG. 4 shows an exploded view of the embodiment of FIG. 1.

FIG. 5 shows a side view of an alternative embodiment of a skinning knife according to the invention.

FIG. 6 is a cross section of the skinning knife of FIG. 5, taken along line 6-6 of FIG. 5.

FIG. 7 is a cross section of the skinning knife of FIG. 5, taken along line 7-7 of FIG. 5.

FIG. 8 shows a front perspective view of a second alternative embodiment of a skinning knife according to the invention.

FIG. 9 shows a top plan view of the embodiment of FIG. 8.

FIG. 10 shows a side elevation view of the embodiment of FIG. 8 in which a skinning blade is shown in phantom, latched in its rearward position.

FIG. 11 shows front perspective view of a third alternative embodiment of a skinning knife according to the invention.

FIG. 12 shows a side cross-sectional view of the embodiment of FIG. 11, in which a skinning blade is shown in phantom latched in its forward position.

FIG. 13 shows a front perspective view of a fourth alternative embodiment of a skinning knife according to the invention.

FIG. 14 shows a side elevation view of the embodiment of FIG. 13 in which a punch blade is shown in phantom, latched in its forward position.

FIG. 15 shows a top plan view of the embodiment of FIG. 13.

FIG. 16 shows a side elevation view of a fifth alternative embodiment of a skinning knife, having a single fixed blade with no moving parts.

FIG. 17 shows a side elevation view of a sixth alternative embodiment of a skinning knife, having a single folding blade shown in a fully extended position indicated by solid lines and a partially folded phantom position indicated by dot-dashed lines.

FIG. 18 shows a perspective view of a conventional knife blade outfitted with an add-on spreading member indicated in dot-dashed lines, accompanied by an exploded side view of the spreading member alone.

### DETAILED DESCRIPTION OF ILLUSTRATIVE EMBODIMENTS

In the following description many details are set forth to provide an understanding of the disclosed embodiments of the invention. However, upon reviewing this disclosure, it will become apparent to one skilled in the art that not all of the disclosed details may be required to practice the claimed invention and that alternative embodiments might be constructed without departing from the principles of the invention.

In general, a skinning knife according the present invention is especially adapted to remove the hide from an animal that has been killed in a hunt. However, the attributes of a knife according to the invention also enable it to be used for other purposes such as, for example, cutting through a single layer of carpet on a roll of carpet, so the terms in the specification and claims should not be construed as limiting the applications covered by the invention.

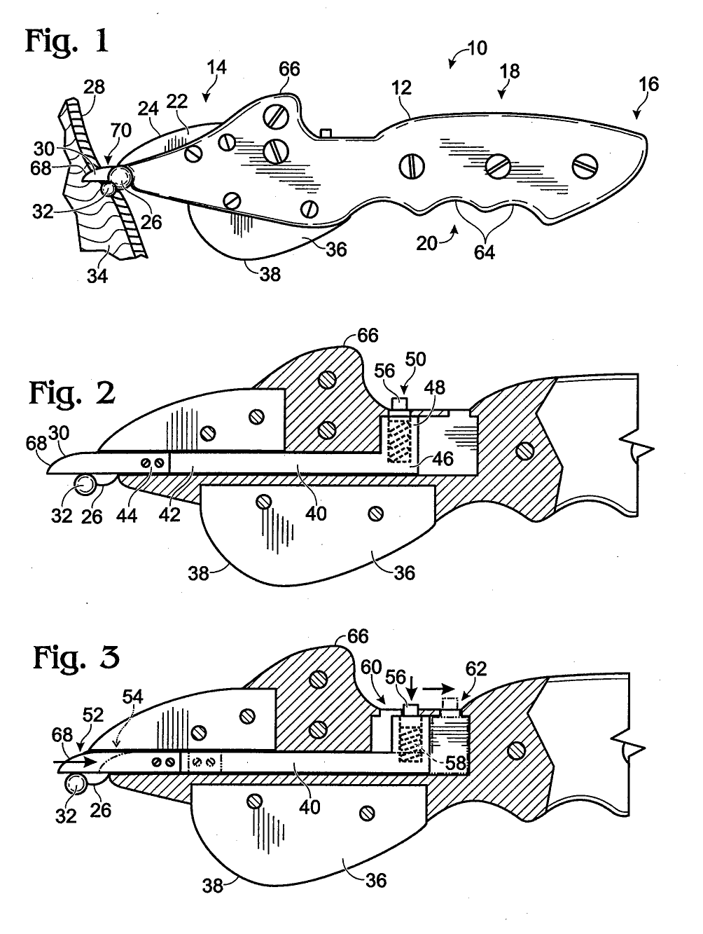

Referring first to FIG. 1, a preferred embodiment of a skinning knife 10 according to the present invention comprises a handle 12, having a forward portion 14, a grip portion 16 disposed behind the forward portion, an upper portion 18, and a lower portion 20. A slitting blade 22 is disposed at the forward portion of the handle. Preferably, the slitting blade has an upwardly- and forwardly-directed cutting edge 24 so as to cut material encountered as the knife is thrust forward. A first spreading member 26 is disposed at the forward most position of the forward portion of the handle so as to spread apart two portions of a first material 28 that have been separated by the slitting blade as the knife is thrust forwardly. A retractable punch blade 30 is disposed at least partially in the forward portion of the handle beneath the slitting blade for opening a hole in the first material when the knife is thrust forwardly. A smaller, second spreading member 32 is disposed below and forward of the first spreading member so as to enter a slit in advance of the first, larger spreading member.

The knife further comprises a skinning blade 36 disposed below the lower portion 20 of the handle for removing the first material 28 from a second material 34 to which it is attached. Preferably, the skinning blade has an arcuate, convex, downwardly directed cutting edge 38. The terms “downwardly” and “upwardly” are defined herein with respect to the handle of a knife oriented as shown in the drawings so that “upwardly directed” means in a direction toward the top of the knife and “downwardly directed” means in a direction toward the bottom of the knife. Accordingly, in the orientation shown in the drawings, “upwardly” is away from the bottom of the page and “downwardly” is toward the bottom of the page.

Turning now to FIGS. 2 and 3, which show the front portion of the handle partially cut away, the knife further comprises an actuation shaft 40 having a forward end 42 attached to a rearward end 44 of the punch blade 30, and a rearward end 46, including an actuation member 48, the actuation shaft being adapted to move the punch blade forwardly and rearwardly. Preferably, the actuation member 48 comprises a latch 50 that allows the punch blade 30 to be latched in either of a forward position 52 or a rearward position 54. Referring particularly to FIG. 3, preferably the latch comprises a thumb tab 56 held outwardly by a spring 58, a forward aperture 60 for receiving the thumb tab to lock the punch blade in the forward position, and a rearward aperture 62 for receiving the thumb tab to lock the punch blade in the rearward position.

The handle 12 preferably further includes finger indentations 64 along the lower portion for gripping the handle, and a hand guard 66 rearward of the slitting blade 22 on the upper portion 18 of the handle to prevent a user's hand from slipping forward onto the slitting blade 22.

For reasons that will be better understood from the description below of the use of the knife, the first material spreading member 26 has a three-dimensional forwardly convex surface for engaging and spreading the two portions of material. More specifically, at least a portion of the first spreading member preferably has a substantially spherical shape. Similarly, the second spreading member 32 has a three-dimensional forwardly convex surface, preferably a substantially spherical surface. Preferably, the second spreading member 32 is somewhat smaller than the first spreading member 26. In the use of the term “substantially spherical” it is to be understood that neither the first nor the second spreading member is necessarily a complete sphere, or even exactly spherical in shape, the term merely being a workable description approximating the preferred shape. Moreover, both the first spreading member and the second spreading member may have other shapes, such as a conical or a triangular shape, without departing from the principles of the invention. Further, the features of both the first spreading member and the second spreading member could be combined into a single, first spreading member without departing from the principles of the invention.

The use of the skinning knife can now be understood in light of the foregoing description. In hunting, the first material 28 is the hide of an animal that has been killed and the second material 34 is the musculature, or meat, of the animal. To remove the hide from the meat, or “skin” the animal, the punch blade 30 is moved to and latched in its forward position 52. The knife is then thrust into the hide such that the punch blade can cut, or punch, a small starter hole in the hide. Preferably, the punch blade has a cutting edge 68 that is upwardly- and forwardly-directed so as to cut material as the knife is thrust forwardly and pulled upwardly. The punch blade allows the user to open a hole large enough for the second spreading member 32. The user can then open up a hole 70 large enough to insert the first spreading member 26 and the slitting blade 22.

Once the first spreading member and the slitting knife are inserted into the hole 70, the punch blade 30 can be retracted. Then, the slitting blade is used to cut through the hide. As the knife is thrust through the hide, the spreading members separate the hide from the meat. After a lengthy slit has been made in the hide, the animal can then be skinned using the skinning blade 36 to free the hide from the meat and separate the hide from the meat.

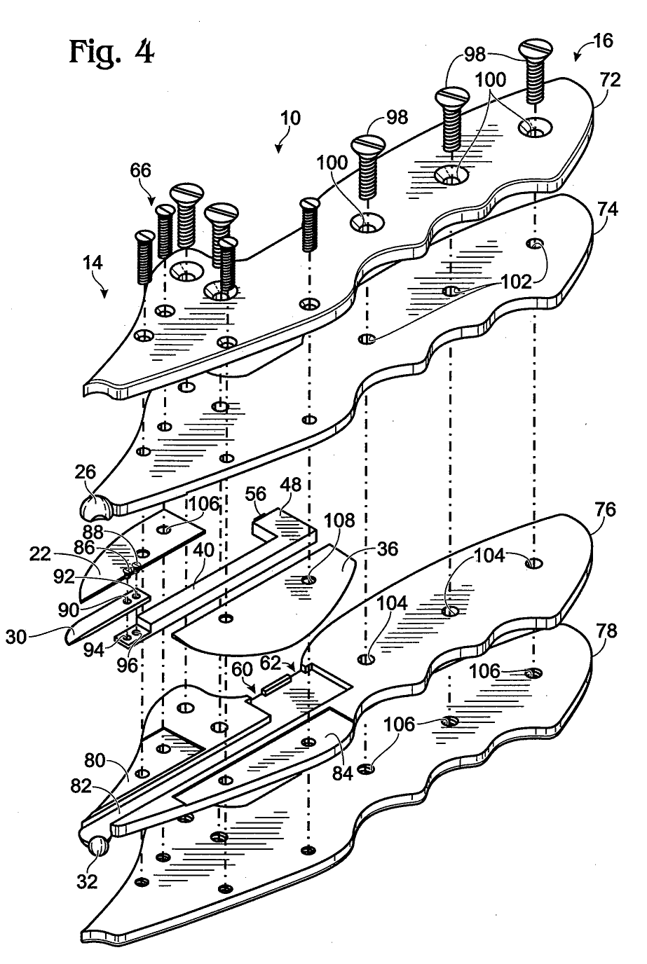

The detailed structure and construction of a preferred embodiment of the skinning knife can be understood by reference to FIG. 4. In the preferred structure the handle comprises a sandwich of four parts: a first cover grip 72, a first inner plate 74, a second inner plate 76, and a second cover grip 78. The second inner plate 76 has a first cavity 80 for receiving the slitting blade 22, a second cavity 82 for receiving the punch blade 30 and actuation shaft 40, and a third cavity 84 for receiving the skinning blade 36. The second cavity 82 also forms the forward aperture 60 and rearward aperture 62 for receiving the thumb tab 56. The punch blade 30 is attached to the actuation shaft 40 by screws 86 and 88, which fit through respective apertures 90 and 92 in the punch blade and engage threaded apertures 94 and 96 in the actuation shaft 40. The entire assembly is then held together by a plurality of screws 98 that fit through respective apertures 100, 102, and 104 in the first cover grip 72, first inner plate 74 and the second inner plate 76, respectively, and engage threaded apertures 100 in the second cover grip 78. In some cases screws 98 also fit through apertures 106 and 108 in the slitting blade 22 and skinning blade 36, respectively. Preferably, the slitting blade, punch blade and skinning blade are made of steel, while the rest of the parts may be made of a lighter weight but sturdy material such as, for example, aluminum.

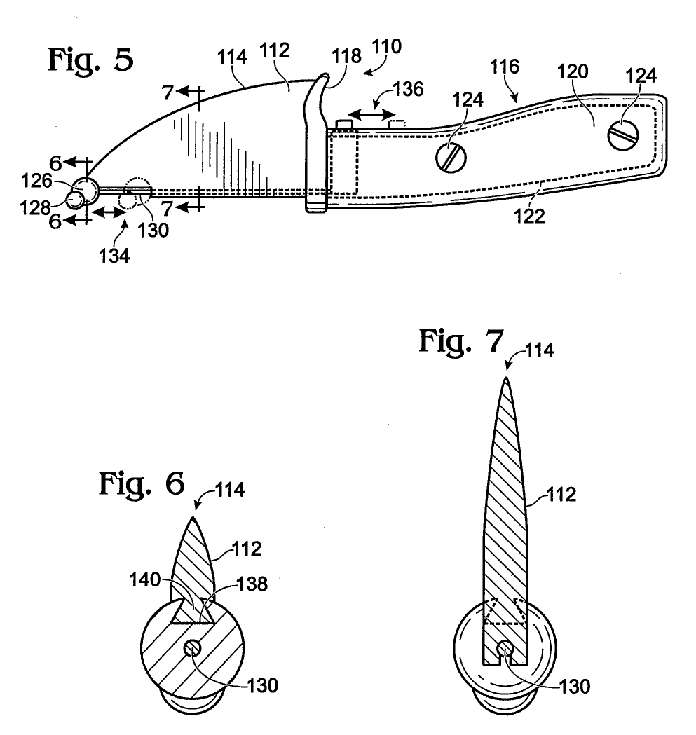

An alternative embodiment of a skinning knife 110 according to the present invention is shown in FIGS. 5, 6 and 7. In this case there is only one multi-purpose blade 112 that has an upwardly- and forwardly-directed cutting edge 114 so as to cut material encountered as the knife is thrust forward. The multi-purpose blade 112 is attached to a handle 116, with a hand guard 118 disposed there between. The handle has a first outer grip 120 and a second, mirror image outer grip (not shown) which cover a blade shank 122 and are attached to the shank by screw 124.

This embodiment also has a first spreading member 126 and a second spreading member 128. However, in this case, the two spreading members are attached to an actuation shaft 130 that is used to place the spreading members at the forward most tip 132 of the knife, or retract the spreading members to a rearward position 134. The spreading members may be latched in place by a thumb tab assembly 136 like that of the first embodiment. In addition, the first spreading member has a groove 138 therein for receiving a tongue 140 on the bottom of the multi-purpose blade 112 so as to guide and position the first and second spreading members 126 and 128, respectively. As in the first embodiment, the features of the first spreading member 126 and the second spreading member 128 may be combined into a single spreading member without departing from the principles of the invention.

In use of alternative skinning knife embodiment 110, the spreading members are initially retracted so that the tip 132 of the multi-purpose blade 112 can be used to punch a hole in the animal hide. Then, the spreading members 126 and 128 are moved to their forward most position so that, as multi-purpose blade 112 is used to slit the hide, the two separated parts of the hide are spread. Finally, when a sufficiently long slit has been made in the hide, the spreading members are again retracted and the multi-purpose blade 112 is used to separate the hide from the meat.

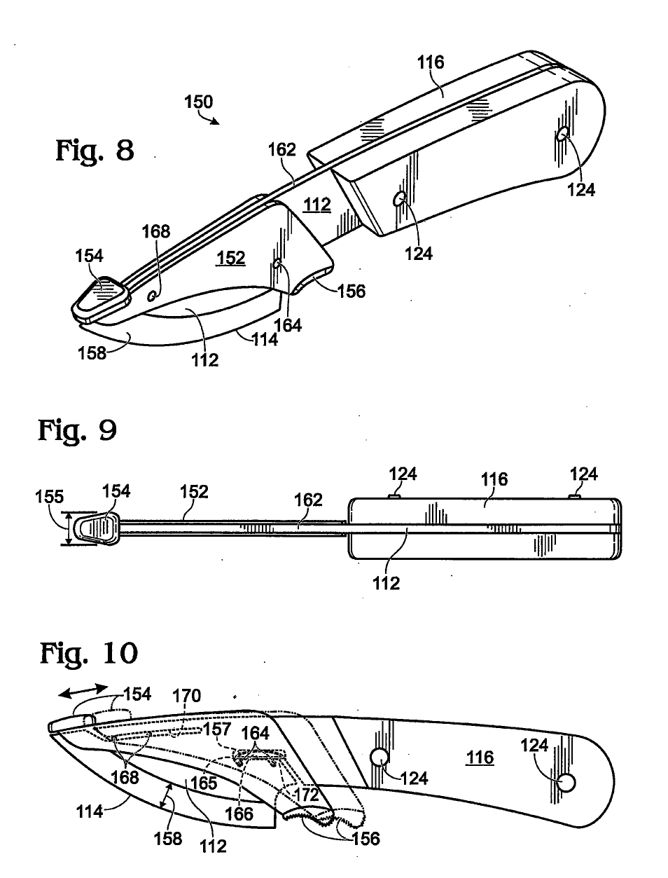

Referring now to FIGS. 8-10, a second alternative embodiment of a skinning knife 150 is shown that is a variant of alternative skinning knife 110. Like skinning knife 110, skinning knife 150 features a multi-purpose blade 112 having a beveled cutting edge 114, and a two-part handle 116 attached on either side to blade 112 by two screws 124. However, skinning knife 150 further provides a two-part blade sheath 152 flanking multi-purpose blade 112, which blade sheath 152 advances and retracts a flat, triangular spreading member 154, having a width 155 and rounded corners. The position of blade sheath 152 is controlled by a sheath thumb tab 156 located on the underside of blade sheath 152, such that the blade sheath 152 in its forward position places triangular spreading member 154 at the tip of multi-purpose blade 112, and in its rearward position retracts triangular spreading member 154 to a location behind the bevel 158 of cutting edge 114. Adjacent upper surfaces of blade sheath 152 support triangular spreading member 154 as spreading member 154 rides back and forth along a top edge 162 of multi-purpose blade 112.

The mechanism that actuates movement of blade sheath 152 and triangular spreading member 154 in skinning knife embodiment 150 is now described with reference to an enlarged side elevation shown in FIG. 10. Depressing a sheath thumb tab 156 compresses a flat spring 157 preferably having overlapping leaves, which unlocks a spring pin 164 from its forward latched position 165 so that it may travel fore and aft within a channel 166 cut into, and accessible from, a lower surface of the tang of blade 112, behind cutting edge 114. The surface of sheath thumb tab 156 may be fashioned with a thumb grip, preferably having a roughened, sticky, or otherwise high-friction surface, to prevent slipping. A second pin 168, located adjacent to triangular spreading member 154, travels in tandem, within a second channel 170, which is accessible from a top surface of blade 112. When spring pin 164 reaches the rearmost extent of its travel, pin 164 drops into a rearward latched position 172 until sheath thumb tab is again depressed. Generally, the ends of the channels 166 and 170 may optionally be notched so as to securely latch the pin into the forward and rearward positions.

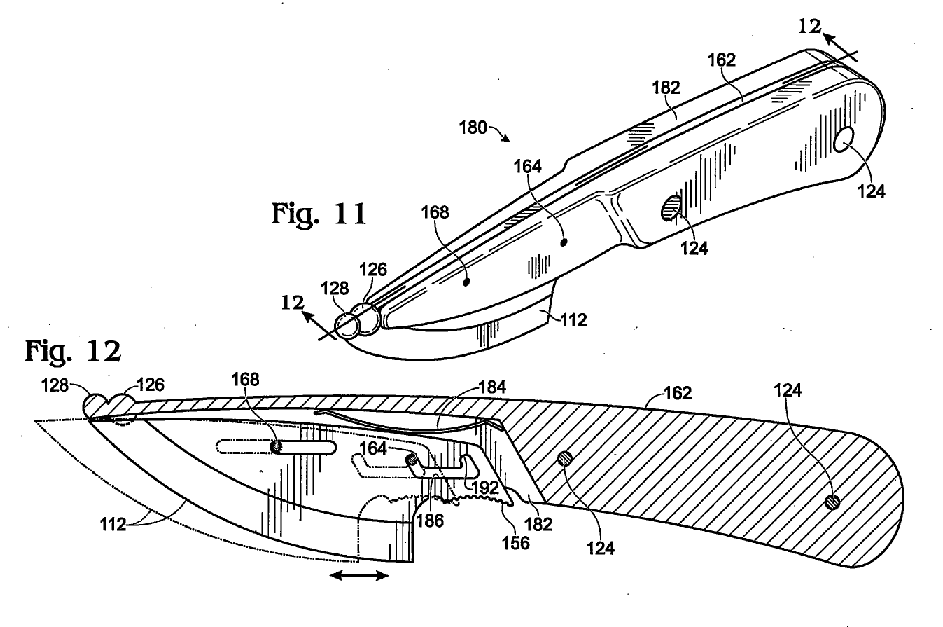

Referring now to FIGS. 11 and 12, a third alternative embodiment of a skinning knife 180 unifies blade sheath 152 and handle 116 into a molded, continuous uni-body handle 182 having attached, at its forward end, first and second spreading members 126 and 128, respectively. Another type of spreading member, such as, but not limited to, triangular spreading member 154, may be used in place of spreading members 126 and 128 without departing from the principles of the invention. Uni-body handle 182 is held together by two screws 124, and visible on the exterior of the sheath portion of handle 182 are spring pin 164 and second pin 168. The mechanism for activating movement between the two latched pin positions in this third embodiment 180, shown in FIG. 12, differs from previous embodiments in that multi-purpose blade 112 itself moves relative to handle 182. Depressing thumb tab 156, which is formed within the lower edge of blade 112, causes blade 112 to compress a metallic strip compression spring 184, and causes spring pin 164 to be lowered into a U-shaped channel 186 cut in blade 112. As blade 112 is pulled back, spring pin 164 travels rearward within U-shaped channel 186 and second pin 168 travels rearward within a straight channel 190. At the end of its travel, spring pin 164 rises into a rearward latched position 192. Generally, the ends of the channels 186 and 190 may be notched so as to securely latch the pin into its forward and rearward positions.

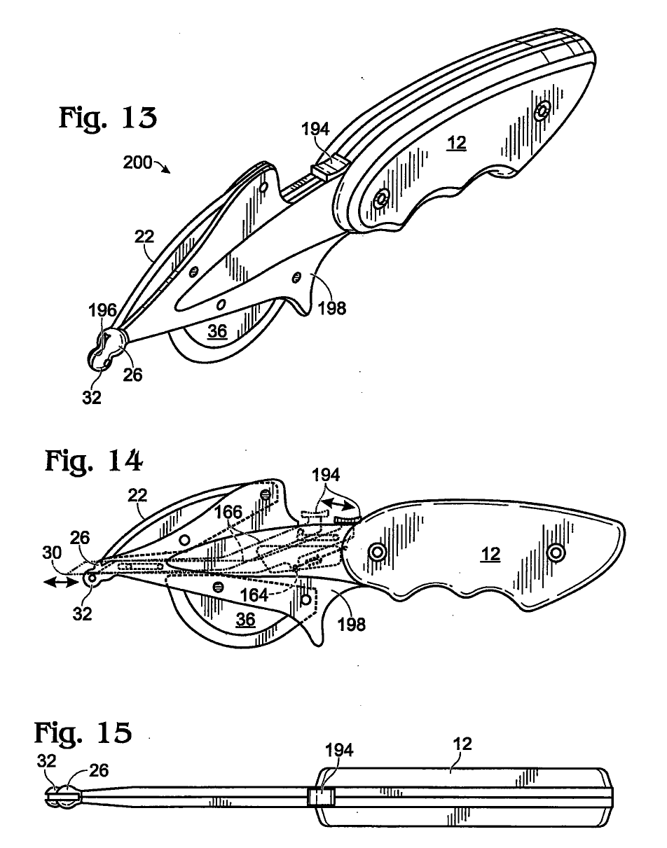

Referring now to FIGS. 13-15, a fourth alternative embodiment of a skinning knife 200 is shown in which the overall skinning knife resembles the preferred tri-blade embodiment 10 shown in FIGS. 1-4, which features the upwardly directed slitting blade 22, the downwardly-directed skinning blade 36, and the retractable punch blade 30. Such a tri-blade configuration allows the user to perform all of the necessary functions for skinning an animal without inverting the orientation of the tool in the hand. Accordingly, finger grips are provided along the lower edge of handle 12. In this embodiment, the actuation mechanism for retracting punch blade 30 is similar to that of the second and third alternative embodiments, in which flat thumb tab 194 releases spring pin 164 for travel within channel 166. In FIGS. 13 and 15, thumb tab 194 is shown in its rearmost latched position such that punch blade 30 is retracted and therefore hidden. When punch blade 30 is extended as shown in FIG. 14, the tip of punch blade 30 emerges through a slot 196 in spreading members 26 and 32 which are fixedly attached in this embodiment 200. Furthermore, handle 12 of the skinning knife 200 has only two screws, and beveled skinning blade 36 is partially covered by a fixed blade guard 198 that protects the user's fingers when grasping handle 12. In skinning knife 200, channel 166 is formed by a relief cut in blade guard 198 rather than being cut in the tang of skinning blade 36 itself. Again, the ends of channel 166 may be notched so as to securely hold spring pin 164 in position.

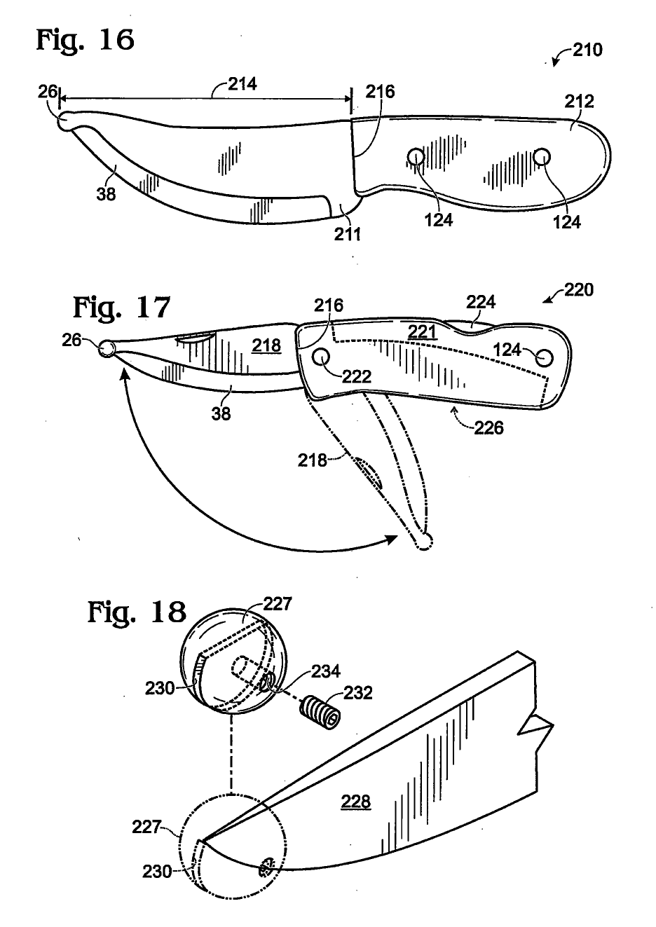

Finally, FIG. 16 shows a single blade embodiment of a skinning knife, 210, which provides the three-dimensional convex spreading member 26 at the tip of a non-adjustable skinning blade 211 having downwardly directed cutting edge 38, and a simple handle 212 that flanks the sides of the tang of blade 211 and is attached by two screws 124. Unlike existing skinning knives that have a fixed spreading member and a concave blade, cutting edge 38 is convex, which allows the user to open a hole in the hide without the need to engage a separate tool or the tip of a second blade. Skinning knife 210 has a fixed blade in which the tang extends through the handle as shown in FIG. 16. Skinning knife 210 may be adapted for use in skinning animals of various sizes by simply altering the length 214 of the blade provided, as measured from the forwardmost extent of spreading member 26 to a front edge 216 of the handle 212, and adjusting the size of the spreading member, accordingly to accommodate varying sizes and thickness of animal hides For example, a 4.25-inch blade may be used for skinning large game animals such as elk and moose, a 3-inch blade may be used for skinning medium-sized animals such as deer and antelope, and a 2-inch blade may be used for skinning smaller, potentially fur bearing animals such as coyote, bobcat, and fox. The unique, fixedly attached, spreading member 26 differentiates skinning knife 210 from existing fixed blade skinning knives.

Fixed blade skinning knife 210, having spreading member 26, may be modified to feature a hinged, folding blade 218 shown in FIG. 17 fully extended in solid lines, and partially folded in dot-dashed lines. Folding skinning knife 220 may include multiple blades of varying types and sizes, such as conventional blades, skinning blades, and other multi-purpose tools commonly supplied with folding knives. Folding skinning knife 220 has a partially hollow folding knife handle 221 of a common, existing design, which includes a hinge 222 located behind front edge 216, and an optional internal locking mechanism activated by a thumb tab 224. Depressing thumb tab 224 releases folding blade 218, allowing folding blade 218 to bend toward the underside of handle 222, into which an opening 226 (shown by hidden lines) is fashioned to receive cutting edge 38 of folding blade 218.

FIG. 18 presents an add-on spreading member 227 that may be used to convert a conventional knife blade 228 into a skinning knife resembling fixed blade embodiment 210. Spreading member 227 comprises a generally convex, closed object, into which a slit 230 may be cut for receiving a sharp tip of knife blade 228. Spreading member 227 may be hollow or solid. In a preferred embodiment, spreading member 229 is spherical; however, in general, consistent with previous embodiments, spreading member 227 may be of any shape that presents a forwardly convex surface in the direction of the tip of knife blade 228. An optional set screw 232 may be mounted orthogonally to the slit 230 through a set screw hole 234 for securing spreading member 226 to knife blade 228 as the set screw is tightened and comes into contact with the surface of knife blade 228. Add-on spreading member 227 is preferably made of one or more materials such as metal, plastic, glass, mineral, or crystalline material, or a similar material suitable for skinning.

The terms and expressions that have been employed in the foregoing specification are used therein as terms of description and not of limitation, and there is no intention, in the uses of such terms and expressions, to exclude equivalents of the features shown and described or portions thereof, it being recognized that the scope of the invention is defined and limited only by the claims which follow.

1. A skinning knife, comprising:
a handle having a forward portion;
a skinning blade disposed at the forward portion of the handle, the skinning blade having a tip and a downwardly-directed cutting edge;
a retractable spreading member for spreading apart two portions of a first material that have been separated by the tip of the skinning blade, the spreading member having a forwardly convex surface for engaging and spreading the two portions of material; and
an actuation mechanism for selectively advancing the spreading member to a forward position that covers the tip of the skinning blade, and retracting the spreading member to a rearward position that exposes the tip of the skinning blade.

2. The skinning knife of claim 1, wherein the forwardly convex surface of the spreading member is three-dimensional.

3. The skinning knife of claim 1, wherein the retractable spreading member has a substantially triangular shape.

4. The skinning knife of claim 1, wherein the actuation mechanism comprises at least a partial blade sheath.

5. The skinning knife of claim 1, wherein the actuation mechanism comprises a spring-loaded thumb tab and a channel having forward and rearward latched positions.

6. The skinning knife of claim 5, wherein the latched positions are set by notches in the channel and a pin for engaging the notches.

7. The skinning knife of claim 5, wherein the channel is cut in the skinning blade.

8. The skinning knife of claim 1, wherein the skinning blade is convex.

9. A skinning knife, comprising:
a handle having a forward portion;
a retractable skinning blade disposed at the forward portion of the handle, the skinning blade having a tip and a downwardly-directed cutting edge;
a spreading member fixedly attached to the forward portion of the handle for spreading apart two portions of a first material, the spreading member having a forwardly convex surface for engaging and spreading the two portions of material;
and an actuation mechanism for selectively advancing the skinning blade to a forward position that exposes the tip of the skinning blade in front of the spreading member, and retracting the skinning blade behind the spreading member to a rearward position that hides the tip of the skinning blade.

10. The skinning knife of claim 9, wherein the forwardly convex surface of the spreading member is three-dimensional.

11. The skinning knife of claim 10, wherein at least a portion of the surface of the spreading member has a substantially spherical shape.

12. The skinning knife of claim 9, wherein the actuation mechanism comprises a spring-loaded thumb tab, a channel having forward and rearward latched positions, notches, and a pin for engaging the notches.

13. The skinning knife of claim 12, wherein the channel is U-shaped.

14. The skinning knife of claim 12, wherein the channel is cut in the skinning blade.

15. The skinning knife of claim 12, wherein the spring-loaded thumb tab engages a metallic strip spring.

16. The skinning knife of claim 9, further comprising a blade sheath.

17. The skinning knife of claim 9, wherein the blade sheath and the handle are molded together to form a continuous uni-body handle.

18. The skinning knife of claim 9, wherein the skinning blade is convex.

19. A skinning knife, comprising:
a handle, having a forward portion, a grip portion disposed behind said forward portion, an upper portion and a lower portion;
a slitting blade disposed at said forward portion and having an upwardly- and forwardly-directed cutting edge so as to cut material encountered as the knife is thrust forwardly;
a first spreading member disposed at the forward most position of said forward portion so as to spread apart two portions of a first material that have been separated by said slitting blade as the knife is thrust forwardly, said spreading member having a three-dimensional forwardly convex surface for engaging and spreading said two portions of material;
a retractable punch blade disposed at least partially in said forward portion beneath said slitting blade for opening a hole in said first material when said knife is thrust forwardly, said punch blade having a forward end and a rearward end, said forward end having a cutting edge, said first material spreading member having a slot therein for receiving said punch blade, and said handle having a punch blade actuation mechanism comprising a spring-loaded thumb tab and a channel having forward and rearward latched positions, said actuation mechanism selectively moving said punch blade forwardly through said slot in said first spreading member and in front thereof and moving said punch blade rearwardly through said slot so as not to protrude forwardly beyond said forwardly convex surface of said first spreading member; and
a skinning blade disposed below said lower portion of said handle for removing said first material from a second material to which it is attached, wherein said skinning blade has an arcuate, convex, downwardly directed cutting edge.

20. The skinning knife of claim 19, wherein the actuation mechanism further comprises notches in the channel and a pin for engaging the notches.

21. The skinning knife of claim 19, further comprising a blade sheath at least partially covering the punch blade.

22. The skinning knife of claim 21, wherein the channel is formed by a relief cut in the blade sheath.

23. A skinning knife, comprising:
a handle;
a convex blade having a downwardly-directed cutting edge, a blade length, and a tip; and
a fixedly attached spreading member disposed at the tip of the blade so as to spread apart two portions of material, the spreading member having a forwardly convex surface for engaging and spreading said two portions of material.

24. The skinning knife of claim 23, wherein at least one of the blade length, the size of the spreading member, and the size of the handle is adapted for skinning animals of varying sizes.

25. The skinning knife of claim 23, wherein the blade is hinged, the handle has an opening, and the hinged blade is adapted to fold into the opening.

26. The skinning knife of claim 25, further comprising additional blades of varying types and sizes.

27. The skinning knife of claim 25, wherein the handle further comprises a thumb tab which, when depressed releases the hinged blade, allowing the downwardly-directed cutting edge of the blade to fold into the opening in the handle.

28. A spreading member, comprising:
a convex object; and
a slit cut in the surface of the object, for accepting a tip of a knife blade so that the tip is covered by the convex object.

29. The spreading member of claim 28, further comprising a set screw mounted in the surface of the object orthogonally to the slit, for securing the spreading member to the knife blade.

30. The spreading member of claim 28, wherein the convex object is made of metal, plastic, glass, mineral or crystalline material, or any combination thereof.
